(19) United States
(12) Patent Application Publication
(10) Pub. No.: US 2005/0048194 A1
(43) Pub. Date: Mar. 3, 2005

(54) Prosthesis coating decision support system

(75) Inventor: Ascher Shmulewitz, Tel Aviv (IL)

Correspondence Address: KUDIRKA & JOBSE, LLP, ONE STATE STREET, SUITE 800, BOSTON, MA, 02109, US

(73) Assignee: LABCOAT LTD.

(21) Appl. No.: 10/654,562

(22) Filed: Sep. 2, 2003

(51) Int. Cl. B05D 3/00

(52) U.S. Cl. 427/2.24; 427/2.1; 427/8

(57) ABSTRACT

Systems and methods consistent with embodiments of the present invention are provided for determining whether and how to coat a prosthesis prior to surgery. In accordance with one embodiment of the invention, a method for coating a prosthesis is provided that includes providing information from one or more sources; electronically analyzing the information to generate at least one treatment plan for coating a prosthesis; and instructing a prosthesis coating device to coat the prosthesis based on the treatment plan.

### BACKGROUND OF THE INVENTION

The practice of coating implantable medical device prostheses with a synthetic or biologically active or inactive agent is known. Numerous processes have been proposed for the application of such a coating. Such processes include: soaking or dipping the implantable device in a bath of liquid medication, soaking in an agitated bath, or spraying the medication by way of pressurized nozzles. Prosthesis coating devices can be used to introduce heat and/or ultrasonic energy in conjunction with a medicated bath.

Initially, such coatings were applied at the time of manufacture. For various reasons, such as the short shelf life of some drugs, the time span from manufacture to implantation, and the possible decision of medical personnel regarding the specific drug and dosage to be used based on various patient-specific factors, a need has arisen for technologies which permit applying a coating just prior to implantation. Accordingly, techniques have been developed for coating just prior to implantation such as: wrapping the implantable device with medicated conformal film, dipping or soaking the device in a medicated bath just prior to implantation, or providing a bathing chamber for use with specific implantable device such as the stent deployed on the balloon of a catheter.

The foregoing methods and devices intended for use just prior to implantation are designed to deposit the coating material onto any and all surfaces that are exposed to the coating. This may result in depositing coating material on surfaces on which the coating is unwanted or undesirable. Further, the coating may crack or break away when the implant device is removed from the implantation apparatus. An example of this would be a stent deployed on a catheter balloon. As the balloon is inflated and the stent is expanded into position, the coating may crack along the interface between the stent and the balloon. These cracks may cause a portion of the coating to break away from the stent itself. Similar problems can occur in cases where the coating technique fails to prevent inadvertent overlapping with the edges of various devices (e.g., struts of stents). This, in turn, may affect the medicinal effectiveness of the coating, and negatively affect the entire medical procedure. Thus, it is important that coating of prosthesis be accurate and timely.

The significance of delivering drug-loaded prostheses may offer savings benefit in time and cost. Studies have been conducted to show the importance of delivering the correct drug dose density on coronary stents to prevent restenosis by application of paclitaxel or rapamycin. Other studies have shown how accuracy of dose relates to cytotoxicity of coating drugs.

There is therefore a need for a method for determining the most appropriate treatment plan for a patient and selectively coating a prosthesis just prior to implantation. It would be desirable for the treatment regimen to provide for physician selection of prosthesis, coating material, and dosage to be applied to address the specific needs of the patient at the time of implantation.

### SUMMARY OF THE INVENTION

Systems and methods consistent with embodiments of the present invention are provided for determining whether and how to coat a prosthesis prior to surgery. In accordance with one embodiment of the invention, a method for coating a prosthesis is provided that includes providing information from one or more sources; electronically analyzing the information to generate at least one treatment plan for coating a prosthesis; and instructing a prosthesis coating device to coat the prosthesis based on the treatment plan.

According to another illustrative embodiment, a prosthesis coating decision support system is provided that includes a workstation to generate a treatment plan for coating a prosthesis to be implanted in a patient; and a prosthesis coating device, wherein the workstation controls said prosthesis coating device to coat a prosthesis according to the treatment plan.

According to another illustrative embodiment, a prosthesis coating decision support method is provided that includes using a workstation to develop a treatment plan; communicating the treatment plan to a physician; and controlling a prosthesis coating device to implement the treatment plan when the treatment plan is approved by the physician.

According to another illustrative embodiment, a prosthesis coating decision support method is provided that includes entering patient information at a workstation; generating one or more treatment plans at the workstation based at least in part on the patient information; selecting one of said one or more treatment plans; and implanting said prosthesis in accordance with said treatment plan.

According to another illustrative embodiment, a computer readable medium containing instructions for use in a process for formulating a treatment plan for use in a prosthesis coating decision support system is provided that includes analyzing information including at least one of: insurance information, credit information, patient records, patient lab data, prosthesis type information, prosthesis availability, coating information, and clinical study results; and generating one or more treatment plans based on the analysis, wherein the one or more treatment plans include at least one of a recommendation as to whether to coat, a prosthesis coating specification, prosthesis architecture, prosthesis material, coating types, coating costs, coating methods, and patient insurance coverage.

### BRIEF DESCRIPTION OF THE DRAWINGS

The accompanying drawings, together with the detailed description, provide a further understanding of illustrative embodiments of the invention disclosed herein. In the drawings:

FIG. 1 depicts a prosthesis coating decision support system, consistent with an illustrative embodiment of the invention;

FIG. 2 is a block diagram of a computing system, consistent with an illustrative embodiment of the invention;

FIG. 3 depicts a prosthesis coating device, consistent with an illustrative embodiment of the invention;

FIG. 4 is a block diagram of a prosthesis coating device with a non-sterile non-replaceable section and a sterile replaceable and reusable section;

FIG. 5 is a block diagram of a treatment plan, consistent with an illustrative embodiment of the present invention;

FIG. 6 is a block diagram of information sources, consistent with an illustrative embodiment of the present invention;

FIG. 7 is a flow diagram of a decision support system, consistent with an illustrative embodiment of the present invention;

FIG. 8 is a flow diagram of a coating procedure, consistent with an illustrative embodiment of the present invention; and

FIG. 9 is a flow diagram of a physician interaction with a decision support system, consistent with an illustrative embodiment of the present invention.

### DETAILED DESCRIPTION

Consistent with illustrative embodiments of the invention disclosed herein, methods and systems are provided for a prosthesis coating decision support system.

The term “prosthesis” as used herein refers to any one of many medical applications including, but not limited to, coronary stents, peripheral vascular stents; abdominal aortic aneurysm (AAA) devices, biliary stents and catheters, TIPS catheters and stents, vena cava filters, vascular filters and distal support devices and emboli filter/entrapment aids, vascular grafts and stent grafts, gastro enteral tubes/stents, gastra enteral and vascular anastomotic devices, gastroenteral catheters and stents, surgical and wound drainings, radioactive needles, bronchial tubes and stents, vascular coils, vascular protection devices, tissue and mechanical prosthetic heart valves and rings, arterial-venous shunts, AV access grafts, surgical tampons, dental implants, CSF shunts, pacemaker electrodes and leads, suture material, wound healing, tissue closure devices including wires, staplers, surgical clips etc., IUDs and associated pregnancy control devices, ocular implants, timpanoplasty implants, hearing aids including cochlear implants, implantable pumps (like insulin pumps), implantable cameras and other diagnostic devices, drug delivery capsules, left ventricular assist devices (LVADs) and other implantable heart support and vascular systems, indwelling vascular access catheters and associated devices (like ports), maxilo fascial implants, orthopedic implants (joint replacement, trauma management and spine surgery devices), implantable devices for plastic and cosmetic surgery, implantable meshes (such as for hernia or for uro-vaginal repair, brain disorders, and gastrointestinal ailments), and other indwelling metal implants.

In general, when a physician is preparing for surgery (for example, any medical intervention, procedure or implantation), a treatment plan is created. The treatment plan may include the use of a prosthesis device with a particular architecture, material, coating type, and coating material, for specifically responding to the medical condition of the patient. The treatment plan may also cover cost and insurance coverage details. In one illustrative embodiment, a prosthesis coating decision support system takes a variety of inputs from information sources, such as a patient profile (including, for example, insurance reimbursement information), image of a legion, DES Inventory, etc., and processes this information to suggest a treatment plan to the physician. Once a physician approves the treatment plan, a prosthesis can be coated according to the treatment plan and then introduced or surgically implanted into the patient.

Illustrative embodiments disclosed herein may be implemented in connection with various types of computing tools. By way of a non-limiting example, one illustrative implementation will be described with reference to a workstation. As can be appreciated by those skilled in the art, many different types of workstations can be used, such as: a general purpose personal computer, PDAs, mobile phones, next-generation phones, settop boxes, thin-client devices, small computing devices, and/or other computing devices.

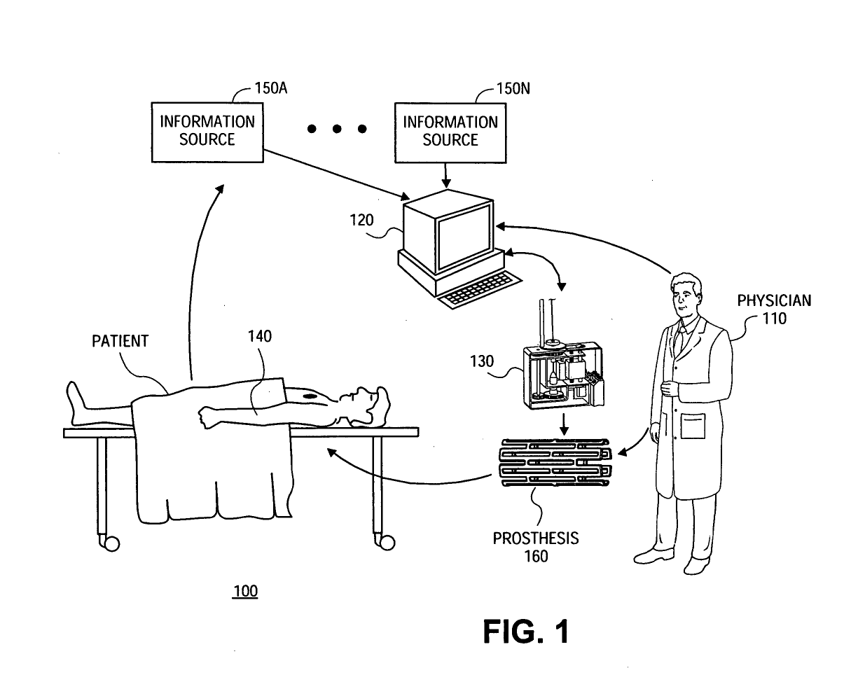

FIG. 1 depicts a prosthesis coating decision support system 100, consistent with one illustrative embodiment. System 100 includes a physician 110, a workstation 120, a prosthesis coating device 130 controlled by the workstation 120, a patient 140, one or more information sources 150A-150N, and a prosthesis 160.

Workstation 120 interacts with information sources 150A-15ON to gather patient information and other data, which is used to create a treatment plan for patient 140. Physician 110 interacts with workstation 120 to determine a treatment plan for patient 140. After selecting a treatment plan, physician 110 receives prosthesis 160, which has been coated by prosthesis coating device 130 according to the treatment plan. The prosthesis 160 can then be implanted in patient 140.

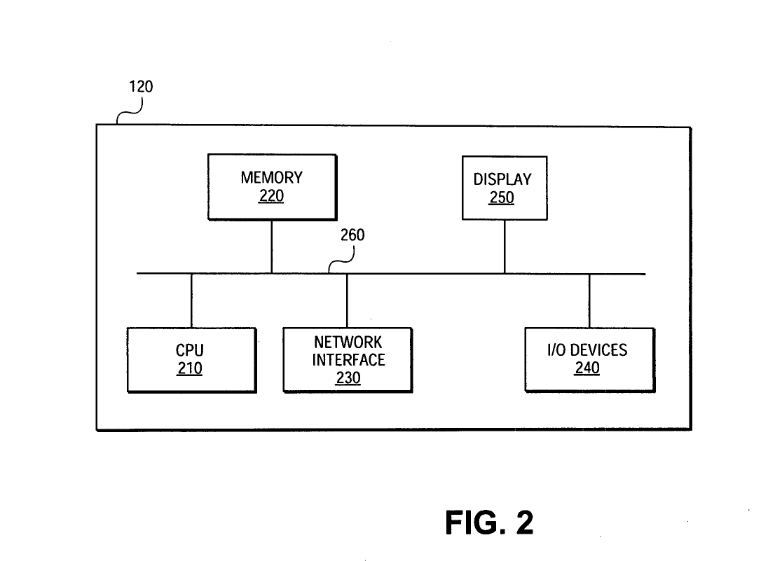

FIG. 2 is a block diagram of an exemplary workstation 120. Workstation 120 may represent, for example, the internal components of a computing device. By way of example, a program or set of instructions running decision support software used to control prosthesis coating device 130 may be implemented on workstation 120.

Workstation 120 may include a number of components, such as a processor or central processing unit (CPU) 210, a memory 220, a network interface 230, I/O devices 240, and/or a display 250. Such components may be, interconnected by a system bus 260. CPU 210 may be a microprocessor such as from the Pentium® family of microprocessors manufactured by Intel Corporation. However, any other suitable microprocessor, micro-, mini-, or mainframe computer may be used, such as a micro-controller unit (MCU), or a digital signal processor (DSP).

Network interface 230, examples of which include Ethernet, dial-up telephone and/or other conventional data port connections, may be used to communicate with other devices or information sources, such as one or more of information sources 150A-150N through, for example, a connection or a communication network (not shown), such as a local area network or the Internet. Workstation 120 may also receive input via input/output (I/O) devices 240, which may include a keyboard, pointing device, or other like input devices. Workstation 120 may also present information and graphical user interfaces via display 250 to a user.

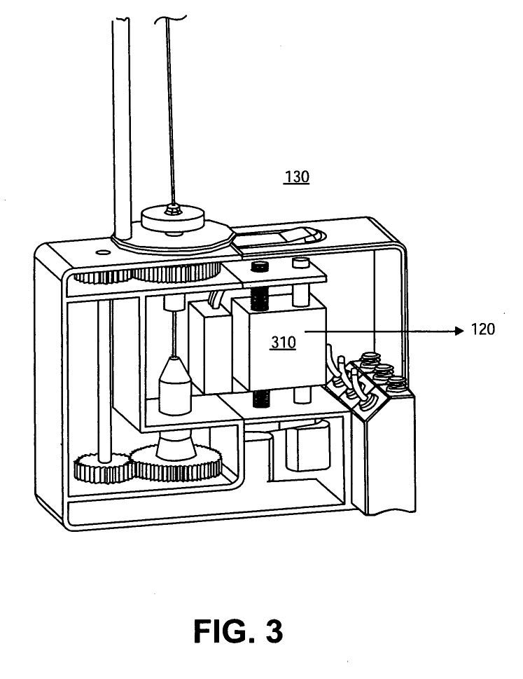

FIG. 3 shows prosthesis coating device 130. Prosthesis coating device may include a processor 310, which is connected to workstation 120. The decision support system may be implemented with software or any combination of hardware, firmware, and/or software to provide the necessary functionality and processes.

Prosthesis coating device 130 may coat using injection coating, for example, as disclosed in “Stent Coating Device,” U.S. patent application Ser. No. 10/136,295, filed May 2, 2002, herein incorporated by reference. Alternatively, prosthesis coating device 130 may coat via contact printing, for example, as disclosed in “Contact Coating of Prostheses,” U.S. patent application Ser. No. 10/256,755, filed Sep. 27, 2002, herein incorporated by reference.

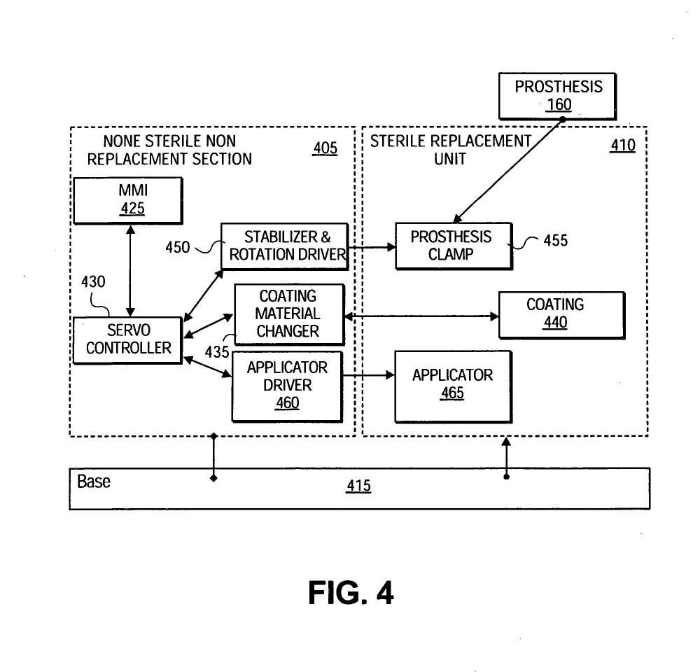

FIG. 4 is a block diagram of an embodiment of the prosthesis coating device 130. The coating device includes a non-sterile non-replaceable section 405 and a sterile replaceable and reusable section 410. Section 405 is permanently mounted on base 415 and section 410 is removably mounted on base 415. Section 405 comprises man-machine interface (MMI) 425, servo controller 430, stabilizer and rotation driver 450, coating material changer 435, and applicator driver 460. In one embodiment, MMI 425 is a user interface, which can include software, and a manual/mechanical interface. MMI 425 contains a processor and user interface. The sterile replaceable and reusable portion comprises prosthesis clamp 455, coating material reservoirs 440, and applicator 465. Both portions can be mounted on a single base. The interfaces are both electrical and mechanical.

Servo controller 430 activates prosthesis stabilizer and rotation driver 450, coating material changer 435, and applicator driver 460. An example of a coating material changer is a tray. Prosthesis stabilizer and rotation driver drives a prosthesis clamp 455, which holds prosthesis 160. Coating material changer 435 drives coating material reservoirs 440. Examples of coating material reservoirs are sponge cartridges. Applicator driver 460 drives applicator 465.

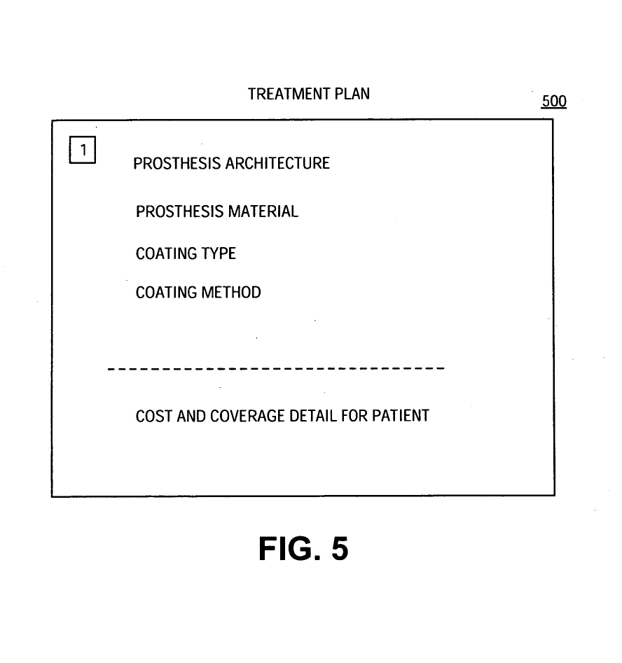

FIG. 5 shows the elements of a treatment plan in accordance with one illustrative embodiment. Treatment plan 500 may be a clinical refinement of a general technical approach in a patient care plan. Treatment plan 500 may include, without limitation: a recommendation as to whether to coat, a prosthesis coating specification with stent details such as stent architecture and material, coating type and method, cost, and insurance coverage detail for the patient.

Treatment plan 500 can be formed based on patient information and clinical studies related to patient information. Treatment plan 500 is generated by a decision support system that incorporates information about the patient, the patient's condition, and specific local availability.

Treatment plan 500 may include a plan for tailored dosing, such as specified coating, based on patient status. Tailored dosing may be used to regionally provide a number of different types of treatments. For example, through tailored dosing, higher concentrations of anti-proliferative drugs may be applied for lacerated lesions. The higher pressure used to perform angioplasty may be correlated to the dosing. For example, intact endoluminal surfaces may require lower dosing than ruptured sites. Tailored dosing may also include immunomodulators applied for thin-capped lesions, to prevent rupture of vulnerable plaque. The drugs needed in this case would be antithrombotics, rather than antiproliferatives. Information from imaging (IVUS) or other diagnostic tools may be used by the decision support system to select the region that is at risk.

Characteristics of the lesion determined through the use of imaging tools can also be used to tailor the dosage in a treatment plan. For example, in the case of a lesion occurring at the branching of a vessel, the treatment plan may call for more drugs applied at the branch. The treatment plan may also call for more drug to be applied at an area of higher lesion buildup. Treatment plan 500 may also provide for different dosing for calcified and non-calcified lesions, based on the drug availability. For example, higher dosing of antiproliferatives for ostial lesions is suggested.

Treatment plan 500 may also include endothelial cell paving for smaller caliber lesions, and diabetic patients. In these patients cell implants may be required. A prosthesis loaded with these cells would require different drugs to increase the likelihood of anchoring and growth in-situ. The positioning of these cell implants should be at points in the vessel with minimal shear forces.

Treatment plan 500 may also include gradient dosing for longer lesions, to lessen drug washout. For example, higher dosing for tortous lesions is suggested. Treatment plan 500 may further include different controlled release timing for multiple drugs on the same implant. The first drug released could be an anti-proliferative, then, after stabilization of the ruptured plaque, cell stimulants could be used to enhance endothelial healing. Treatment plan 500 may also include insurance reimbursement information as to particular coating options.

As different clinical practices exist to treat bifurcations and ostial lesions, the treatment plan may include layering two prosthesis, or three stent surfaces, at the bifurcation site. The physician could reduce the dose on the stent surfaces facing the bifurcation to prevent over-dosing that region.

A decision support system, in one embodiment implemented in part as software on workstation 120 (FIG. 1) may use a set of rules to generate a treatment plan. The rules may be based on general and physician-specific clinical standards of practice, cost constraints, regulatory constraints, medical necessity requirements, patient specific requirements, and pharmacokinetic principles. The clinical staff may provide rules to the decision support system. The decision support system will receive information and analyze the information based on the rules to generate a treatment plan.

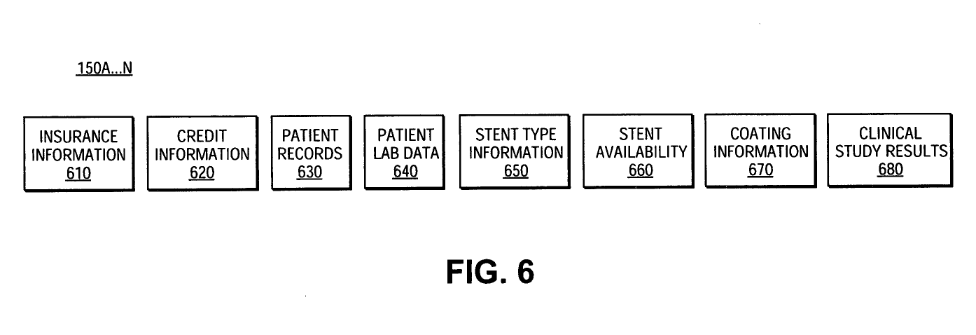

FIG. 6 shows the different types of information (for example, available via one or more of information sources 150A-150N), which may be used by the decision support system to formulate treatment plan 500. Examples of the type of information used by the system include, insurance information 610, credit information 620, patient records 630, which may include both patient profile information and imaging information, patient lab data 640, stent type information 650, stent availability 660, coating information 670, and clinical study results 680. As it becomes available, other types of information may be accessed and utilized by the prosthesis coating decision support system.

In one embodiment, a drug eluting stent inventory (DESI) may be used by the decision support system. The DESI is an electronic database comprised of catheter and stent availability, including novel pioneering products, drug and controlled release systems, stent strut material, passive coatings, and types of coatings. In another embodiment, a Patient Profile (PP) may be used by the decision support system. The Patent Profile is an electronic database comprised of multi-plane angiographic imaging data, hemodynamic data, medical record, biochemical laboratory record, and other information (e.g.: IVUS).

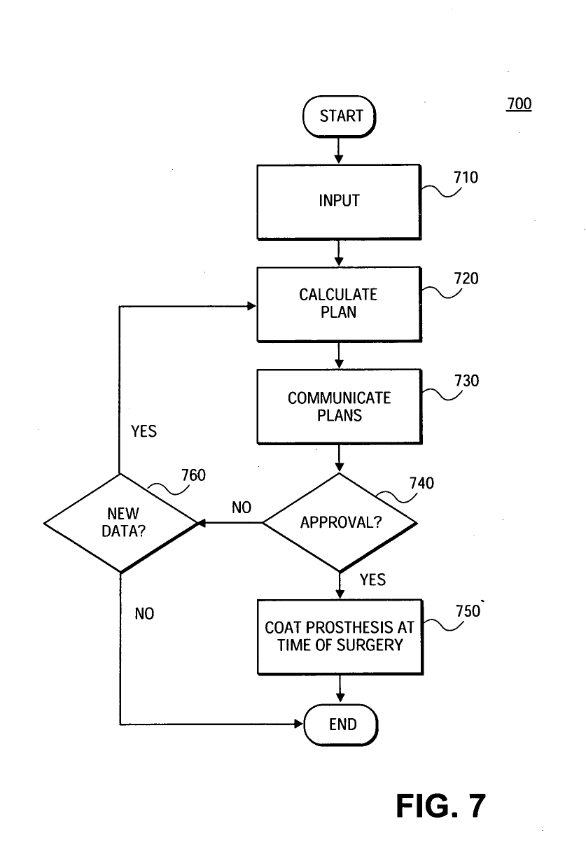

FIG. 7 shows a method 700 for implementing treatment plan 500 in a decision support system. This method can be executed, for example, by software operating on workstation 120. First, information is input into the decision support system (step 710). The user may identify or select the parameters from a pre-programmed list of possible information sources, such as sources 150A-150N described in FIG. 6. Treatment plan 500 is then formulated, as discussed above with reference to FIG. 5 (step 720). The treatment plan is communicated to the physician or other medical personnel (step 730). Before creating a prosthesis based on the treatment plan, the system looks for approval (step 740), for example, from the physician performing the procedure. If the plan is approved, the prosthesis may be coated, according to the treatment plan, at the time of surgery (step 750).

If there is no approval of the treatment plan, the system may receive new data or input (step 760). If no new data is received, then the system may exit, and the physician can tailor his or her own treatment plan. If new data is received, the system may create a new treatment plan. The physician may not approve the plan due to many characteristics, such as overriding cost-based decisions, recent changes to patient status, or discomfort with the planned technical approach. The physician may also include new constraints or sources of data for the decision support system to consider, in which case the system will return to step 720 to re-calculate a plan based on the new data. New data may include updated patient information, such as status or lab information, as well as updated physician analysis of the most viable treatment option.

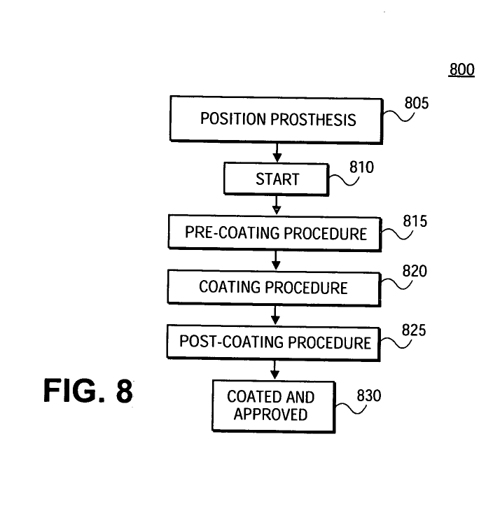

FIG. 8 shows an example of the steps performed in coating the prosthesis 160 (step 750 of FIG. 7), when the prosthesis is a stent that is to be coated with a therapeutic agent. The stent and therapeutic agent container are positioned in the prosthesis coating device (step 805). The system is then ready for processing the stent. The system is started by the user (step 810), and the pre-coating procedure is executed (step 815). The pre-coating procedure includes collecting information (e.g., coating type and coating method from treatment plan 500) in the processing unit of the stent coating device to be used during the coating procedure. The coating and post coating procedures are then executed (steps 820-825). The post-coating procedure verifies that the stent has been properly coated and should be approved for use (step 830).

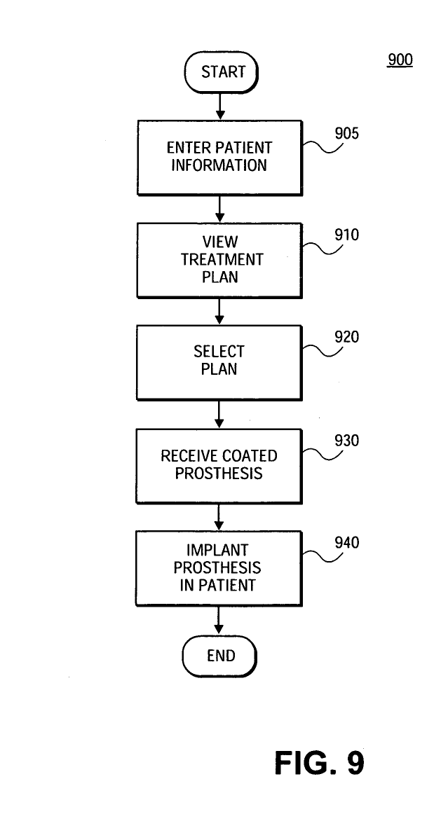

FIG. 9 shows the steps performed by a physician in connection with the method for implementing a treatment plan shown in FIG. 7. First, the patient information is entered into the system (step 905). This information can include images of the legion and patient medical status. Next, treatment plans are viewed (step 910). A number of different treatment plans may be viewed based on projected effectiveness or insurance coverage. Alternatively, only one treatment plan is presented. The physician selects and approves a plan if more than one are presented (step 920). After selecting the treatment plan, the prosthesis is coated at the prosthesis coating device 130. The physician then receives a prosthesis with a coating based on the treatment plan (step 930). Upon receipt of the coated prosthesis, the physician can immediately implant the prosthesis in the patient (step 940).

Other embodiments of the invention will be apparent to those skilled in the art from consideration of the specification and practice of the embodiments of the invention disclosed herein. It is intended that the specification and examples be considered as exemplary only, with a true scope and spirit of the invention being indicated by the following claims.

1. A method for coating a prosthesis, comprising:
(A) providing information from one or more sources;
(B) electronically analyzing the information to generate at least one treatment plan for coating a prosthesis; and
(C) instructing a prosthesis coating device to coat the prosthesis based on the treatment plan.

2. The method of claim 1, wherein the prosthesis is coated at the time of surgery.

3. The method of claim 1, wherein the prosthesis coating device uses injection coating.

4. The method of claim 1, wherein the prosthesis coating device uses contact printing.

5. The method of claim 1, wherein the information includes information from at least one of DESI and PP databases.

6. The method of claim 1, wherein the information is analyzed using rules.

7. The method of claim 6, wherein the rules are based on at least one of:
general and physician-specific clinical standards of practice, cost constraints, regulatory constraints, medical necessity requirements, patient specific requirements, and pharmacokinetic principles.

8. The system of claim 1, wherein the information includes one or more of:
insurance information, credit information, patient records, patient lab data, prosthesis type information, prosthesis availability, coating information, and clinical study results.

9. A prosthesis coating decision support system comprising:
a workstation to generate a treatment plan for coating a prosthesis to be implanted in a patient; and
a prosthesis coating device, wherein the workstation controls said prosthesis coating device to coat a prosthesis according to the treatment plan.

10. The system of claim 9, further comprising one or more information sources coupled to said workstation, the information sources providing information used by the workstation to generate the treatment plan.

11. The system of claim 10, wherein the information includes one or more of:
insurance information, credit information, patient records, patient lab data, prosthesis type information, prosthesis availability, coating information, and clinical study results.

12. The system of claim 10, wherein the information sources include at least one of the DESI and PP databases.

13. The system of claim 9, wherein the treatment plan includes one or more of: a recommendation as to whether to coat, a prosthesis coating specification, prosthesis architecture, prosthesis material, coating types, coating costs, coating methods, and patient insurance coverage.

14. A prosthesis coating decision support method comprising:
(A) using a workstation to develop a treatment plan;
(B) communicating the treatment plan to a physician; and
(C) controlling a prosthesis coating device to implement the treatment plan when the treatment plan is approved by the physician.

15. The method of claim 14, wherein the treatment plan recommends not coating the prosthesis.

16. The method of claim 14, wherein the workstation is a personal computer.

17. The method of claim 14, wherein the workstation controls the prosthesis coating device.

18. The method of claim 14, further comprising providing information to the workstation used to develop the treatment plan.

19. The method of claim 18, wherein the information includes one or more of:
insurance information, credit information, patient records, patient lab data, prosthesis type information, prosthesis availability, coating information, and clinical study results.

20. The method of claim 19, wherein the information is provided from at least one of the DESI and PP databases.

21. The method of claim 19, wherein the treatment plan includes one or more of:
a recommendation as to whether to coat, a prosthesis coating specification, prosthesis architecture, prosthesis material, coating types, coating costs, coating methods, and patient insurance coverage.

22. The method of claim 14, wherein a plurality of treatment plans are developed by the workstation and communicated to the physician, and the step (C) includes controlling the prosthesis coating device implement the treatment plan selected and approved by the physician.

23. A prosthesis coating decision support method comprising:
(A) entering patient information at a workstation;
(B) generating one or more treatment plans at the workstation based at least in part on the patient information;
(C) selecting one of said one or more treatment plans; and
(D) implanting said prosthesis in accordance with said treatment plan.

24. The method of claim 23, further comprising coating the prosthesis according to said treatment plan prior to step (D).

25. The method of claim 23, wherein the one or more treatment plans include one or more of: a recommendation as to whether to coat, a prosthesis coating specification, prosthesis architecture, prosthesis material, coating types, coating costs, coating methods, and patient insurance coverage.

26. A computer readable medium containing instructions for use in a process for formulating a treatment plan for use in a prosthesis coating decision support system, the process including:
(A) analyzing information including at least one of: insurance information, credit information, patient records, patient lab data, prosthesis type information, prosthesis availability, coating information, and clinical study results.
(B) generating one or more treatment plans based on the analysis of step (A), wherein the one or more treatment plans include at least one of a recommendation as to whether to coat, a prosthesis coating specification, prosthesis architecture, prosthesis material, coating types, coating costs, coating methods, and patient insurance coverage.
